(19) United States
(12) Patent Application Publication
(10) Pub. No.: US 2005/0146882 A1
(43) Pub. Date: Jul. 7, 2005

(54) Retractable light shade

(76) Inventors: Huang-Chen Liao, Taichung City (TW); Shu-Fang Lee, Yun Lin Hsien (TW)

Correspondence Address: Huang-Chen Liao, PO Box 82-144, Taipei, TW

(21) Appl. No.: 10/751,969

(22) Filed: Jan. 7, 2004

(51) Int. Cl. F21V 1/16

(52) U.S. Cl. 362/352; 362/357

(57) ABSTRACT

A retractable light shade that saving packaging volume and thus the freight cost, is made of fabric sewn into a tubular shape with circumferences of both ends each encircled with a wire to define respectively an upper and a lower frames; multiple eyelets being provided on the upper frame and a fixation lever being disposed crossing the lower frame; and one side of the fabric shade being adhered with extension free paper to serve as a lining for the shade after the sewing work to allow the shade being compressed or stretched as desired.

### BACKGROUND OF THE INVENTION

(a) Technical Field of the Invention

The present invention is related to a light shade, and more particularly, to a retractable one.

(b) Description of the Prior Art

As illustrated in FIGS. 1, 2 and 2A of the accompanying drawings, a light shade (11) of the prior art is usually made of fabric (12) sewn into tubular shape with its upper end (13) and lower end (14) each covered up with a wire ring, a support comprised of a central ring (16) and multiple levers (15) arranged in radius with the ring as the center being arranged at the lower end (14). A tubular, transparent inner shade made of plastic material (PS preferred) is inserted into the shade (11) to stretch up the shade (11) so to hold it in shape. However, the prior art for consuming too much packaging and freight volume, and thus the shipment cost is not viable in terms of economic.

### SUMMARY OF THE INVENTION

The primary purpose of the present invention is to provide a retractable light shade having a lining of an elongation free paper to allow the shade to be compressed for transportation or stretched up in shape for use to achieve the purpose of saving packaging materials and freights.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the prior art.

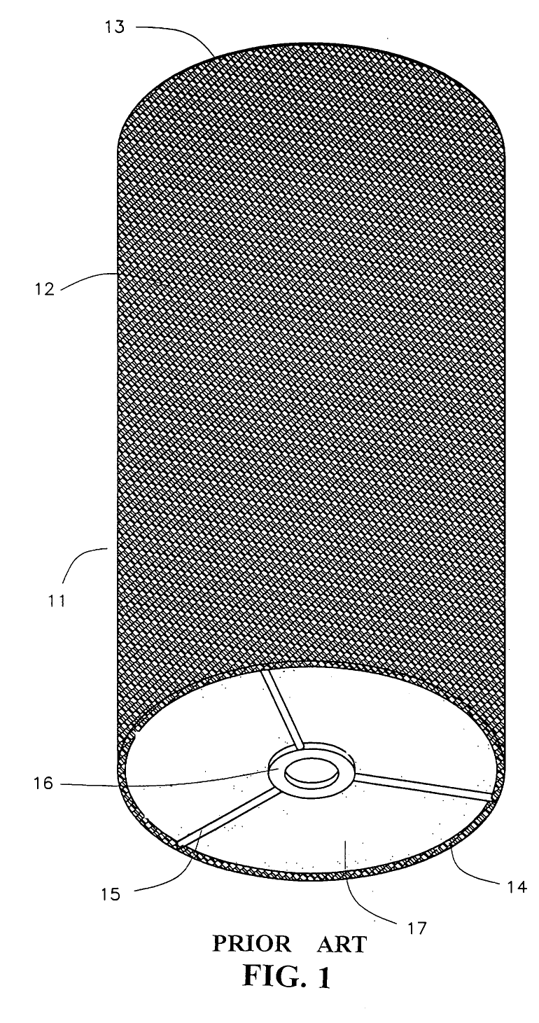

FIG. 2, 2A are sectional views with a local blowup of the prior art.

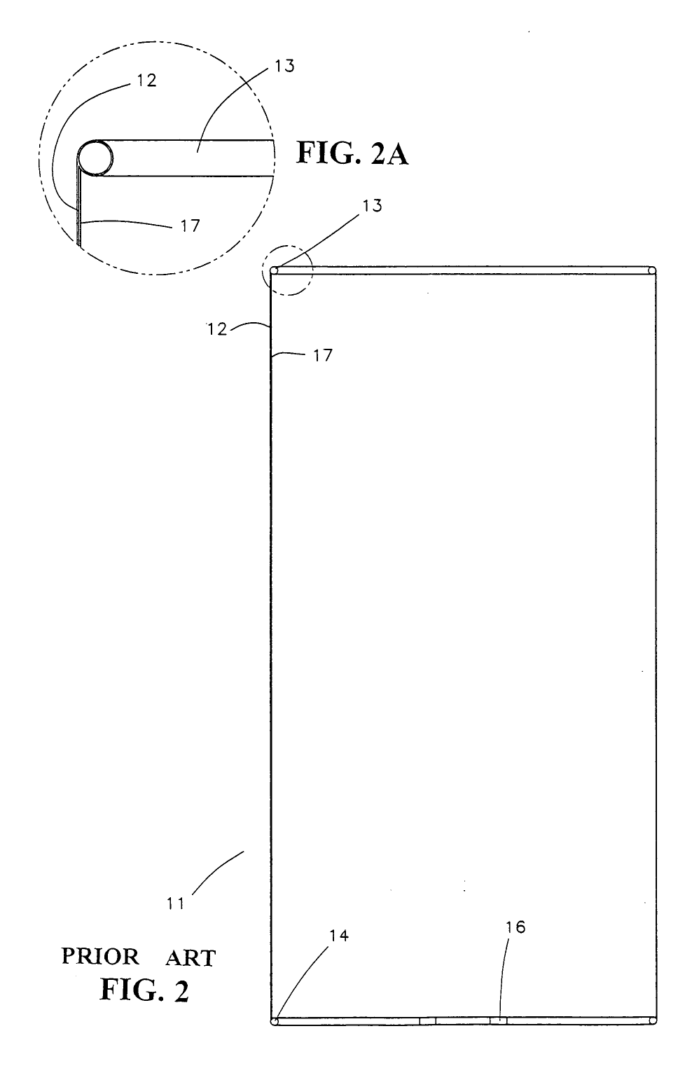

FIG. 3 is a perspective view of a preferred embodiment of the present invention.

FIG. 4 is a schematic view showing that the preferred embodiment of the present invention is compressed.

FIG. 5 is a schematic view showing a paper lining and a fabric of the preferred embodiment of the present invention.

FIG. 6 is another perspective view of the preferred embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

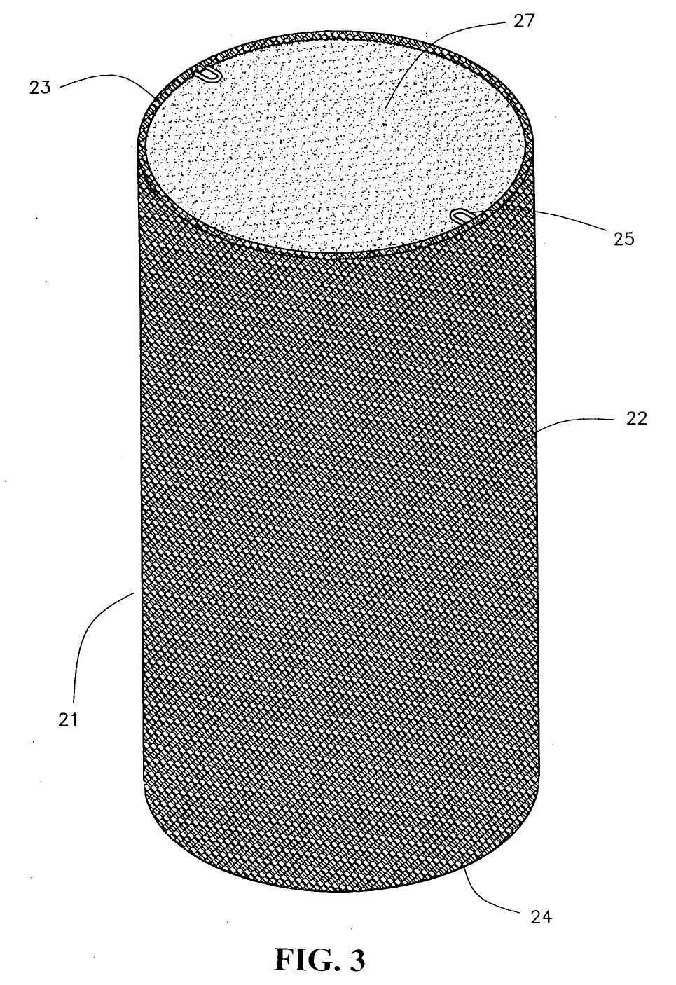

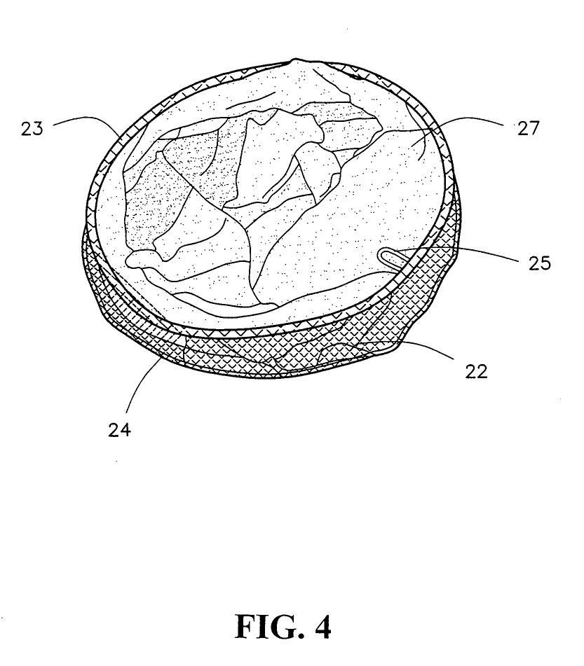

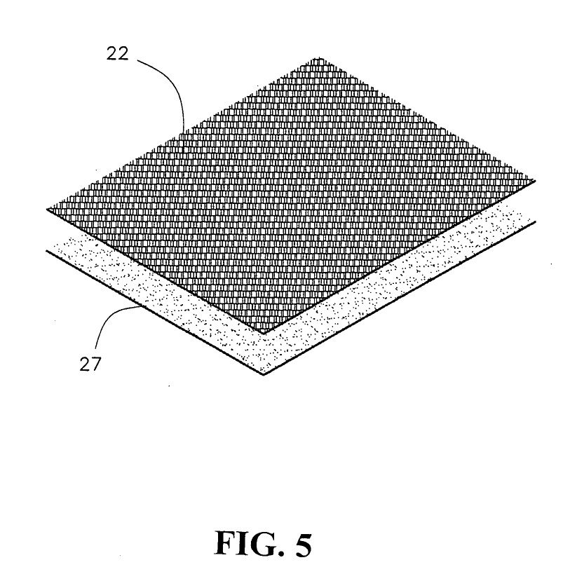

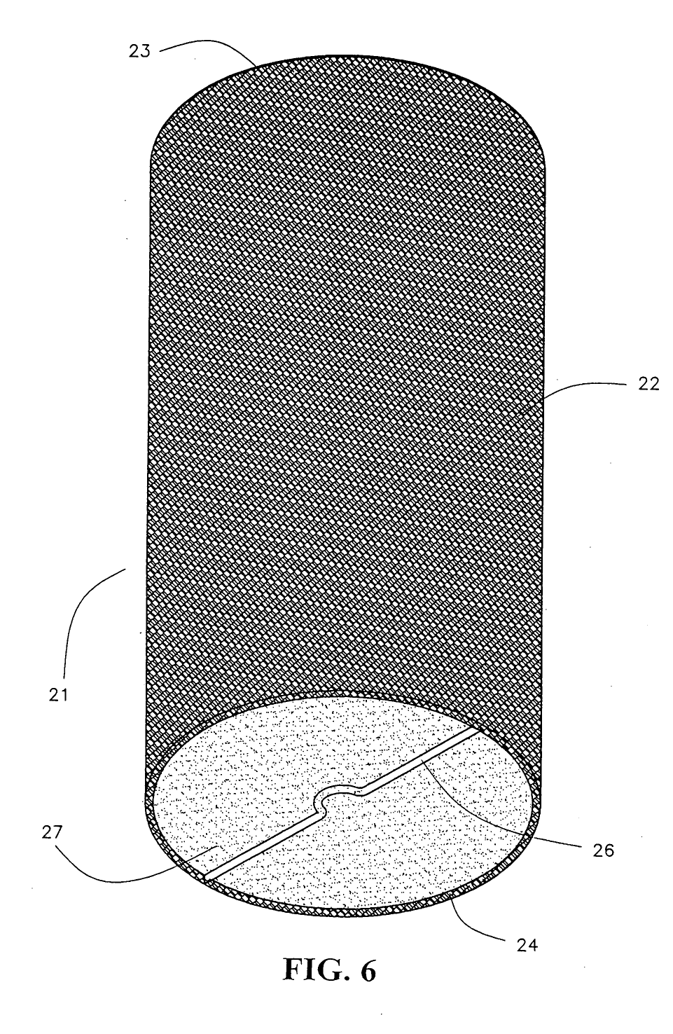

Referring to FIGS. 3 through 6, a preferred embodiment of the present invention related to a retractable light shade (21) is made of a piece of fabric (22) sewn into a tubular shape with the circumferences on both ends of the shade (21) each encircled with a wire to respectively define an upper frame (23) and a lower frame (24). Multiple rings eyelets (23) (two in the preferred embodiment) are provided to the upper frame (23) and a fixation lever (26) is provided crossing the diameter of the lower frame (24).

On one side of the fabric (22) of the shade (21) is adhered with a non-elongation paper (27) to serve as the lining of the shade (21) to allow it to be compressed for shipping or stretched up for use to save packaging space, and thus the freights.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes m the forms and details of the device illustrated and in its operation can be made by those skilled in the art without departing in any way from the spirit of the present invention.

1. A retractable light shade allowing to be compressed for shipping or stretched up for use as desired is made of fabric sewn into tubular shape; circumferences of both ends of the shade being each encircled with a wire to define an upper frame and a lower frame; multiple eyelets being disposed to the upper end; a fixation lever being provided crossing the diameter of the lower frame; and a non-elongation paper being adhered as a lining to the fabric of the shade.
